(19) United States
(12) Patent Application Publication
(10) Pub. No.: US 2011/0002520 A1
(43) Pub. Date: Jan. 6, 2011

(54) Method and System for Automatic Contrast Phase Classification

(75) Inventors: Michael Suehling, Plainsboro, NJ (US); David Liu, Princeton, NJ (US); Grzegorz Soza, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignees: Siemens Corporation, Iselin, NJ (US); Siemens Aktiengesellschaft, Munich (DE)

(21) Appl. No.: 12/828,335

(22) Filed: Jul. 1, 2010

Related U.S. Application Data
(60) Provisional application No. 61/222,254, filed on Jul. 1, 2009.

(51) Int. Cl. G06T 7/00

(52) U.S. Cl. 382/131; 382/154

(57) ABSTRACT

A method and system for classifying a contrast phase of a 3D medical image, such as a computed tomography (CT) image or a magnetic resonance (MR) image, is disclosed. A plurality of anatomic landmarks are detected in a 3D medical image. A local volume of interest is estimated at each of the plurality of anatomic landmarks, and features are extracted from each local volume of interest. The contrast phase of the 3D volume is determined based on the extracted features using a trained classifier.

This application claims the benefit of U.S. Provisional Application No. 61/222,254, filed Jul. 1, 2009, the disclosure of which is herein incorporated by reference.

### BACKGROUND OF THE INVENTION

The present invention relates to medical imaging of a patient, and more particularly, to automatic classification of a contrast phase in computed tomography (CT) and magnetic resonance (MR) images.

In order to enhance the visibility of various anatomic structures and blood vessels in medical images, a contrast agent is often injected into a patient. Medical images of the patient can be obtained using various imaging modalities, such as CT or MR. However, the injection of the contrast agent is not typically tied to the image acquisition device used to obtain the medical images. Accordingly, medical images typically do not contain contrast phase information regarding how long the image acquisition time was after the contrast injection time.

In clinical routines, contrast phase information is typically added manually to image meta data (e.g. in a DICOM header) by a technician at the image scanner. For example, some verbal description is typically added to the series description or image comments DICOM fields. However, this information is not structured or standardized, and is usually only understandable by a human reader. Medical images are typically automatically stored with a timestamp representing an image acquisition time. Based on the image acquisition time of the images, the relative time delay between multiple scans can be determined automatically, but not the delay after the start of contrast injection. In order to effectively pre-process a medical image, it is crucial to determine the contrast phase of the image (i.e., when the image was obtained relative to the contrast injection). Accordingly, fully automatic identification of a contrast phase of an image is desirable.

### BRIEF SUMMARY OF THE INVENTION

The present invention provides a method and system for automatic classification of a contrast phase of a medical image. Embodiments of the present invention utilize a trained classifier to classify the contrast phase of a medical image into one of a predetermined set of phases using a trained classifier. Embodiments of the present invention can classify a contrast phase of an image from the single image or from multiple images at different phases.

In one embodiment of the present invention, a plurality of anatomic landmarks are detected in a 3D medical image. A local volume of interest is estimated at each of the plurality of anatomic landmarks, and features are extracted from each local volume of interest. The contrast phase of the 3D volume is determined based on the extracted features using a trained classifier.

These and other advantages of the invention will be apparent to those of ordinary skill in the art by reference to the following detailed description and the accompanying drawings.

### BRIEF DESCRIPTION OF THE DRAWINGS

FIG. 1 illustrates a method of automatically classifying a contrast phase of a medical image according to an embodiment of the present invention;

FIG. 2 illustrates vessels in the head/neck region;

FIG. 3 illustrates the abdominal aorta and vena cava;

FIG. 4 illustrates the portal vein and connected vessels;

FIG. 5 illustrates a volume of interest estimated for a detected landmark;

FIG. 6 illustrates multi-class response binning of landmark feature values in a 3-class example;

FIG. 7 illustrates Markov Random field modeling of the temporal dependency of the multiple contrast phases; and

FIG. 8 is a high level block diagram of a computer capable of implementing the present invention.

### DETAILED DESCRIPTION

The present invention is directed to a method and system for automatic classification of a contrast phase in medical images, such as computed tomography (CT) and magnetic resonance (MR) images. As used herein, the “contrast phase” of an image is an indication of when the image was acquired relative to a contrast injection. Embodiments of the present invention are described herein to give a visual understanding of the anatomic landmark detection method. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, it is to be understood that embodiments of the present invention may be performed within a computer system using data stored within the computer system.

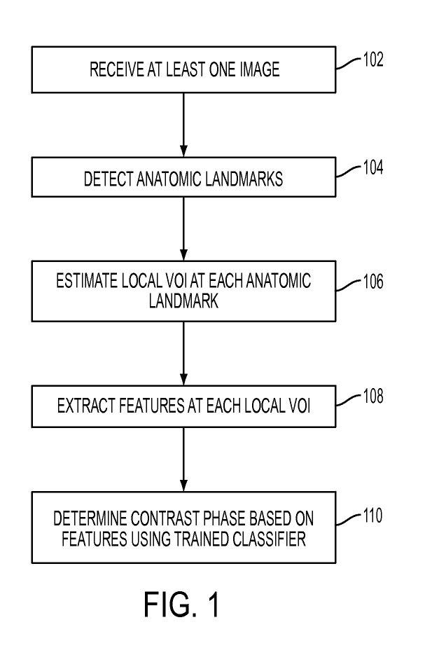

FIG. 1 illustrates a method of automatically classifying a contrast phase of a medical image according to an embodiment of the present invention. The method of FIG. 1 transforms medical image data representing anatomy of a patient to detect a particular set of anatomic landmarks in the medical image data and use features extracted from the anatomic landmarks to indentify a contrast phase of the medical image. At step 102, at least one medical image is received. The medical image can be a 3D medical image (volume) generated using any type of medical imaging modality, such as MR, CT, X-ray, ultrasound, etc. The medical image can be received directly from an image acquisition device (e.g., MR scanner, CT scanner, etc.). It is also possible that the medical image can be received by loading a medical image that was previously stored, for example on a memory or storage of a computer system or a computer readable medium.

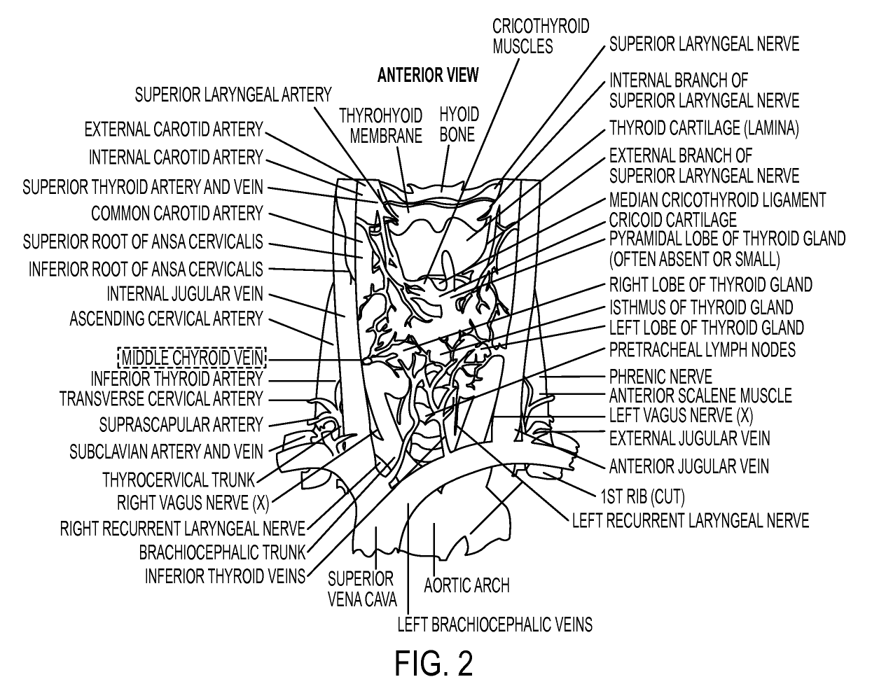

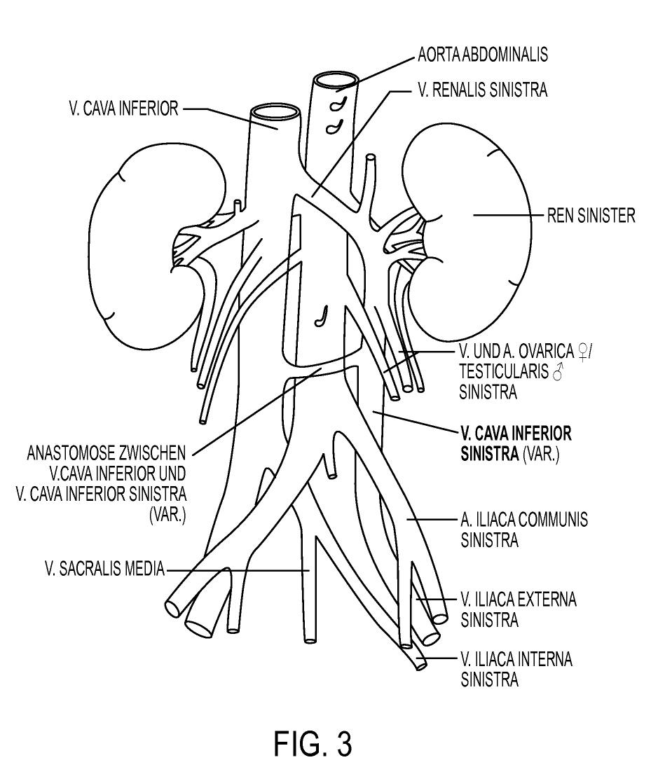

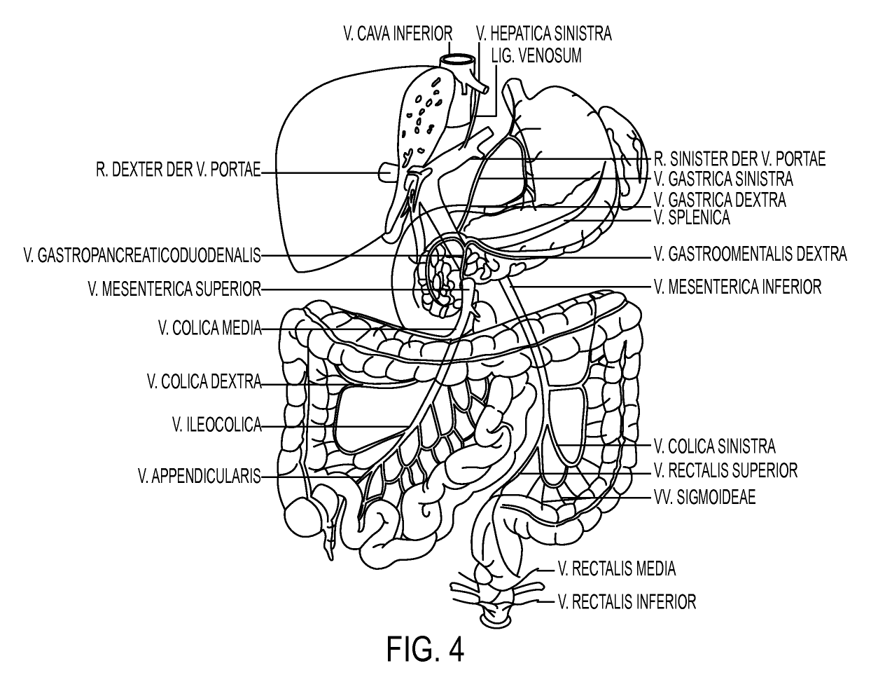

At step 104, a plurality of anatomic landmarks are detected in the medical image. The detected anatomic landmarks can include target landmarks and reference landmarks. Target landmarks are anatomic landmarks in crucial contrast enhancing regions. For example, the detected target landmarks can include various blood vessels (i.e., arteries and veins) that show contrast at various times after the contrast injection and various organs that light up with the contrast agent at specific contrast phases. Reference landmarks are landmarks in non-enhancing regions which are used to provide reference values for comparison with the target landmarks. FIGS. 2-4 illustrate vessels and organs in various regions of the body. FIG. 2 illustrates vessels in the head/neck region. FIGS. 3-4 illustrate vessels and organs in the thorax/abdominal regions. In particular, FIG. 3 illustrates the abdominal aorta and vena cava and FIG. 4 illustrates the portal vein and connected vessels. According to embodiments of the present invention, various vessels and organs shown in FIGS. 2-4 can be detected as target landmarks.

The plurality of detected landmarks can be detected in the 3D medical image using an automatic landmark and organ detection method. For example, a method for detecting anatomic landmarks and organs in a 3D volume is described in United States Published Patent Application No. 2010/0080434, which is incorporated herein by reference. Using the method described in United States Published Patent Application No. 2010/0080434, the anatomic landmarks may be detected as follows. One or more predetermined slices of the 3D medical image can be detected. The plurality of anatomic landmarks (e.g., representing various vessels) and organ centers can then be detected in the 3D medical image using trained landmark and organ center detectors connected in a discriminative anatomical network, each detected in a portion of the 3D medical image constrained by at least one of the detected slices.

As described above, various target landmarks n crucial contrast enhancing regions are detected. According to a possible implementation, the target landmarks in the head and neck region (FIG. 2) can include: left and right arteria carotis communis; left and right vena jugularis interna; and thyroid gland (shows strong enhancement during the arterial phase). The target landmarks in the thorax/abdominal region (FIGS. 3 and 4) can include: right atrium of the heart; left atrium of the heart; aorta; vena cava inferior suprarenal (enhances during the portal venous inflow phase (delay ˜30 seconds)); vena cava inferior infrarenal (enhances after portal venous phase (delay ˜>=2 minutes)); vena splenica (=lienalis) (enhancement of vena splenica indicates beginning of portal venous phase); vena mesenterica (after the vena splenica, the vena mesenterica enhances indicating the start of the portal venous phase); spleen (in the arterial phase, the spleen exhibits a hypo- and hyperdense stripe pattern); cortex of the kidney (high enhancement in the arterial phase); renal medulla of the kidney (enhances later then cortex of the kidney); liver parenchyma (almost no enhancement in the arterial phase and highest enhancement in the venous phase); hepatic artery; portal vein; and hepatic vein.

In addition to the above described target landmarks located in crucial contrast-enhancing locations, reference landmarks can be detected in non-enhancing regions such as bone structures and fat regions. Instead of only relying on feature values of the vessel (target) landmarks, the classification method can additionally utilize non-enhancing landmark regions by considering differences or ratios between the two classes of landmarks. This may be particularly useful for MR images, where the absolute image intensities may vary depending on slight changes on the acquisition conditions and different protocols used.

As described above, the landmarks can be detected using the method described in United States Published Patent Application No. 2010/0080434. Based in the anatomic regions contained in the medical image, only a partial subset of detected landmarks may be returned. Although a specific set of landmarks are described above, it is to be understood that the present invention is not limited thereto.

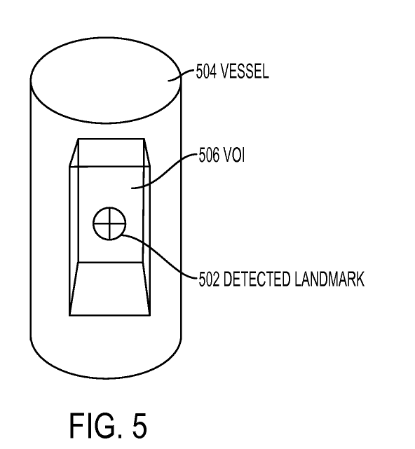

Returning to FIG. 1, at step 106, a local volume of interest (VOI) is estimated surrounding each detected anatomic landmark. The size of the VOI for each detected landmark can be determined by each respective landmark detector and locally adapted to the image data of the medical image. For example, a local ray casting algorithm can be used to detect the vessel boundaries. The local VOI size for each landmark is then determined such that is only covers a central portion of the vessel to avoid influence of the region vessel when extracting features from the VOI. FIG. 5 illustrates a VOI estimated for a detected landmark. As illustrated in FIG. 5, a landmark 502 is detected at a certain vessel 504, and a VOI 506 is estimated surrounding the detected landmark 502. The VOI 506 is estimated such that is only covers a central portion of the vessel 504 and does not overlap with the boundaries of the vessel 504.

Returning to FIG. 1, at step 108, features are extracted from each local VOI. Features are extracted based on intensity information within each local VOI estimated from each detected landmark. For example, features such as mean intensity, local gradient, etc. may be extracted from each VOI. It is also possible to compare each target landmark intensity to the reference landmark intensities to calculate a ratios and differences between each target landmark intensities and the reference landmark intensities.

At step 110, the contrast phase of the medical image is determined based on the extracted features using a trained classifier. According to an embodiment of the present invention, a multi-class machine-learning based classification algorithm can be used to estimate the contrast phase of the medical image from the features extracted at the detected landmark positions. A classifier is trained using features extracted from training data and the trained classifier is used to classify the medical image as one of a set of predetermined contrast phases. For example, for abdominal scans, typical phases xᵢ to be estimated are:
1. Native phase: Image acquired before contrast agent injection;
2. Arterial phase: Image acquired approximately 10-20 seconds after contrast injection (enhancement of the hepatic artery);
3. Portal venous inflow phase (also referred to as late arterial phase): Scan delay of 25-30 seconds (enhancement of the hepatic artery and some enhancement of the portal venous structures);
4. Portal venous phase: Scan delay of 60-70 seconds;
5. Delay phase 1 (Vascular equilibrium phase): Scan delay of 3-5 minutes; and
Delay phase 2 (Parenchyma equilibrium phase): Scan delay of 10-15 minutes.

The above list of contrast phases covers typical routine cases, but is not intended to limit the present invention. The contrast phases may be adapted to specific clinical settings by adding or removing phases such as renal diagnostics where corticomedullary and nephrographic phases may be acquired. The ground truth phase information from each image data set used for training the classifier is provided by a clinical expert. Embodiments of the present invention can classify a contrast phase of an image from the single image or from multiple images at different phases.

Single Phase Classification. In the case of phase classification using a single 3D medical image, multi-class Probabilistic Boosting Tree (PBT) framework can be used to estimate the contrast phase label xᵢ from a given single-phase image zᵢ. Accordingly, a multi-class PBT classifier is trained to estimate the contrast phase label xᵢ based on the features extracted in VOIs surrounded the detected landmarks in given single-phase image zᵢ. In particular, features fₖ input to the trained classifier can include the feature values (mean intensity, local gradient, etc.) extracted at each target landmark position, as well as the ratios and differences between each target landmark intensity and the reference landmark intensities. Reference landmark intensities may be calculated as the mean over several landmarks in the same structure, such as several positions of bone or several positions of fat. The use of this relative intensity feature values ensures that the system is more robust against global intensity changes of images caused by different imaging conditions, especially in MR images. It is to be understood that the classifier is trained using the same types of features extracted in training data of which the contrast phase is known.

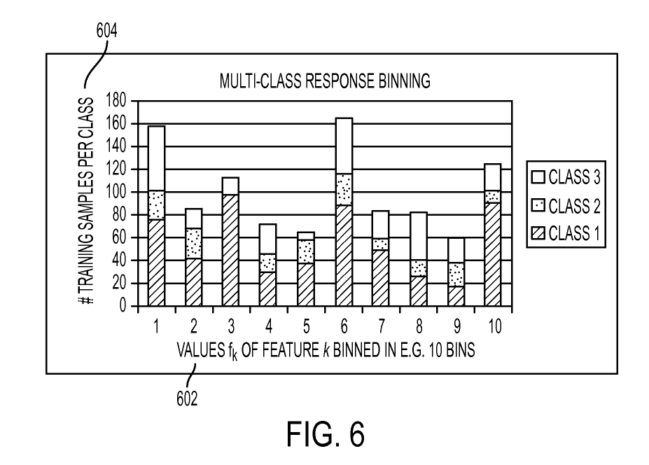

The PBT classifier utilizes a set of weak classifiers corresponding to the set of features fₖ to classify the contrast phase of the medical image. Accordingly to an advantageous implementation, multi-class response binning of the feature values can be used. During training, for each feature fₖ, a joined response histogram over all class labels is calculated using a bin width Δfₖ. FIG. 6 illustrates multi-class response binning of landmark feature values in a 3-class example. As illustrated in FIG. 6, axis 602 shows 10 bins corresponding to values fₖ of a particular feature k, axis 604 shows the number of training samples for each class (1, 2, and 3) for each bin. At the decision stage, the weak classifier for each feature assigns the class label for the extracted feature value fₖ that has the highest cardinality in the corresponding bin. The boosting process favors those features which are most discriminative. In addition to the class label the trained classifier also returns a probability Φ(xᵢ,zᵢ) that a contrast phase xᵢ is assigned to a given image zᵢ.

Multi-Phase Scans. In the case in which multi-phase scans (i.e., multiple 3D medical images of a patient taken sequentially at multiple contrast phases) are available and need to be classifier, the classifier can be enhanced by using a Markov model to exploit the temporal relationship between different phases. The time differences between different contrast phases are typically reproducible and therefore can add additional robustness to the classifier, as compared with relying only on independent phase by phase classifications for a set of multi-phase images.

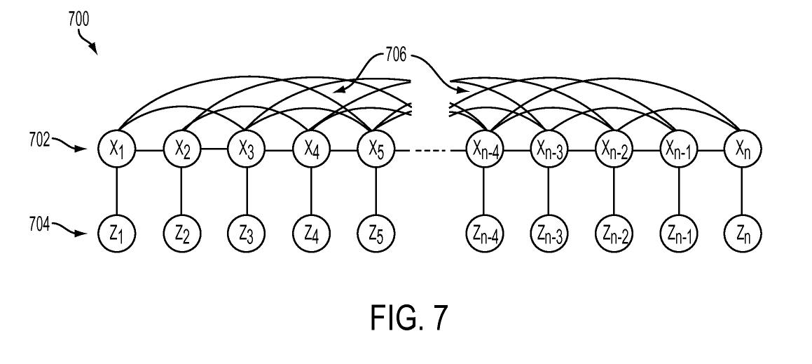

A Markov network (undirected graph) can be used to model the relationship between phases. FIG. 7 illustrates Markov Random field modeling of the temporal dependency of the multiple contrast phases. As illustrated in FIG. 7, a graph topology 700 is denoted as G(E,V), where V=(x₁, . . . , xₙ) denotes the set of contrast phase labels 702 corresponding to a set of images (z₁, . . . , zₙ) 704 and E denotes the set of undirected edges 706 between vertices 702. The local evidence that a given image observation zᵢ is mapped to a contrast label xᵢ is modeled by the likelihood function Φ(xᵢ,zᵢ) of the multi-class PBT classifier, as described above. The relationship between the contrast phases is modeled by a compatibility function Ψ(xᵢ,xⱼ). This compatibility function is modeled as a Gaussian distribution learned from the time differences Δtᵢⱼ=t(zᵢ)−t(zⱼ) of the given multi-phase images, where t(zᵢ) denotes the acquisition time of image zᵢ, which can be extracted from the DICOM header of image zᵢ. In particular, the compatibility function can be defined as:

$$Ψ ( {x}_{i} , {x}_{j} ) ∝ exp ( - \frac{{( Δ {t}_{ij} - {μ}_{ij} )}^{2}}{2 {σ}_{ij}^{2}} ) ,$$

where μᵢⱼ and σᵢⱼ denote the mean and standard deviation of the time differences Δtᵢⱼ learned from the training set of multi-phase images with given contrast labels xᵢ and xⱼ. The joint probability function of the observed images z and the corresponding contrast phase labels x can be expressed as:

$$p ( x , z ) = \frac{1}{Z} {\prod }_{i , j ∈ E} Ψ ( {x}_{i} , {x}_{j} ) {\prod }_{i ∈ V} Φ ( {x}_{i} , {z}_{i} ) .$$

Here, Z denotes a normalization constant such that p(x,z) yields a probability function.

At the inference stage (during classification of the multi-phase images), the goal is to estimate the most probable set of class labels x for a given set of multi-phase images z. This is given by the maximum a posteriori probability:

$${X}_{MAP} = {argmax}_{x} p ( x , z ) .$$

This inference problem can be solved efficiently using well-known methods, such as Belief Propagation.

As described above, the method of FIG. 1 utilizes a categorical classifier output, which classifies an image into a category (e.g., native, arterial, etc.), but the present invention is not limited thereto. For example, a regression variant of the classifier may be used instead of or in addition to the categorical classifier output to output a numeric value of the contrast phase on a continuous “contrast time line”.

In clinical applications, the following regions of the body are scanned most frequently: head/neck, thorax, abdomen, thorax/abdomen combined, head/neck/thorax/abdomen combined, runoffs, and whole body. According to embodiments of the present invention, separate contrast phase classifiers can be trained for each of the above body region combinations. Furthermore, the list of body regions may vary depending on clinical site specific requirements. The landmark detection method used in step 104 and described in United States Published Patent Application No. 2010/0080434, is capable of first determining the body region contained in the image data and then detecting a corresponding subset of landmarks. This ensures that the contrast phase classifier does not suffer from missing inputs.

Since in some cases the scan range of an image may differ from frequently used scan ranges, not all landmarks may be observed in each scan. However, the trained classifier may still expect the input features from all landmarks. Accordingly, the missing features may be imputed by modeling the relationship between missing features and observed features using a linear regression model. The missing features are aligned with the imputed values, and an updated linear regression model is estimated. This process can be iteratively applied until the feature values converge. After the missing feature values have been estimates, the classification method described above can then proceed.

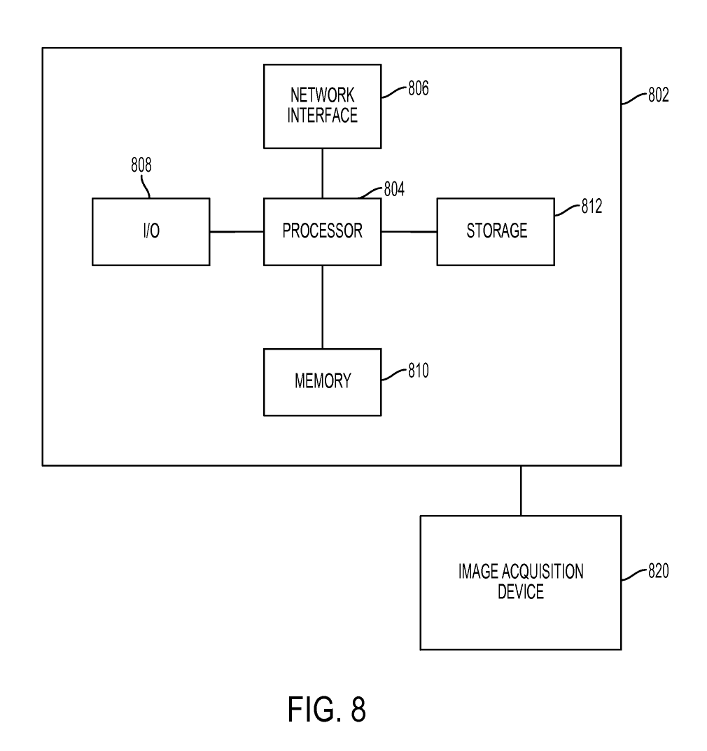

The above-described methods for phase classification of medical images may be implemented on a computer using well-known computer processors, memory units, storage devices, computer software, and other components. A high level block diagram of such a computer is illustrated in FIG. 8. Computer 802 contains a processor 804 which controls the overall operation of the computer 802 by executing computer program instructions which define such operations. The computer program instructions may be stored in a storage device 812, or other computer readable medium (e.g., magnetic disk, CD ROM, etc.) and loaded into memory 810 when execution of the computer program instructions is desired. Thus, the steps of the method of FIG. 1 may be defined by the computer program instructions stored in the memory 810 and/or storage 812 and controlled by the processor 804 executing the computer program instructions. An image acquisition device 820, such as an MR scanning device or a CT scanning device, can be connected to the computer 802 to input medical images to the computer 802. It is possible to implement the image acquisition device 820 and the computer 802 as one device. It is also possible that the image acquisition device 820 and the computer 802 communicate wirelessly through a network. The computer 802 also includes one or more network interfaces 806 for communicating with other devices via a network. The computer 802 also includes other input/output devices 808 that enable user interaction with the computer 802 (e.g., display, keyboard, mouse, speakers, buttons, etc.). One skilled in the art will recognize that an implementation of an actual computer could contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for automatic contrast phase classification in at least one 3D medical image, comprising:
detecting a plurality of anatomic landmarks in the at least one 3D medical image;
estimating a local volume of interest (VOI) surrounding each of the detected plurality of anatomic landmarks in the 3D medical image;
extracting one or more features from each local VOI; and
determining a contrast phase of the at least one 3D medical image using a trained contrast phase classifier based on the extracted features.

2. The method of claim 1, wherein said step of detecting a plurality of anatomic landmarks in the at least one 3D medical image comprises:
detecting a plurality of a target landmarks in contrast-enhancing regions of the at least one 3D medical image; and
detecting at least one reference landmark in a non contrast-enhancing region of the at least one 3D medical image.

3. The method of claim 2 wherein said plurality of target landmarks comprise a plurality of vessels in the at least one 3D medical image.

4. The method of claim 2, wherein said at least one reference landmark comprises at least one of a bone region and a fat region in the at least one 3D medical image.

5. The method of claim 2, wherein said step of extracting one or more features from each local VOI comprises:
extracting an intensity value from the local VOI surrounding each of the plurality of target landmarks and the at least one reference landmark; and
calculating at least one of a ratio and a difference between each intensity value extracted for each of the plurality target landmarks and the intensity value extracted for the at least one reference landmark.

6. The method of claim 1, wherein said step of estimating a local VOI surrounding each of the detected plurality of anatomic landmarks in the 3D medical image comprises:
detecting boundaries of a vessel corresponding to each anatomic landmark; and
estimating the local VOI to cover central portion of the vessel without overlapping the boundaries of the vessel.

7. The method of claim 1, wherein said step of extracting one or more features from each local VOI comprises:
extracting at least one of a mean intensity and a local gradient from each local VOI.

8. The method of claim 1, wherein said step of determining a contrast phase of the at least one 3D medical image using a trained contrast phase classifier based on the extracted features comprises:
determining the contrast phase of the at least one 3D medical image to be one of a plurality of predetermined contrast phases using the trained contrast phase classifier.

9. The method of claim 8, wherein the plurality of predetermined contrast phases comprises a native phase, an arterial phase, a portal venous inflow phase, a portal venous phase, a delay phase 1, and a delay phase 2.

10. The method of claim 1, wherein the trained contrast phase classifier is a multi-class Probabilistic Boosting Tree (PBT) classifier trained based on training images of different contrast phases.

11. The method of claim 1, wherein the at least one 3D medical image comprises a multi-phase sequence of 3D medical images, and said step of determining a contrast phase of the at least one 3D medical image using a trained contrast phase classifier based on the extracted features comprises:
determining the contrast phase of each of the 3D medical images using a Markov model based on the extracted features for each 3D medical image and a temporal relationship between each of the 3D medial images.

12. The method of claim 11, wherein said step of determining the contrast phase of each of the 3D medical images using a Markov model based on the extracted features for each 3D medical image and a temporal relationship between each of the 3D medial images comprises:
maximizing a probability function based on a likelihood function and a compatibility function, wherein the likelihood function is determined by the trained contrast phase classifier based on the extracted features and represents the likelihood of a certain contrast phase for each of the 3D medical images, and the compatibility function is a Gaussian distribution learned from time differences between respective ones of the 3D medical images.

13. An apparatus for automatic contrast phase classification in at least one 3D medical image, comprising:
means for detecting a plurality of anatomic landmarks in the at least one 3D medical image;
means for estimating a local volume of interest (VOI) surrounding each of the detected plurality of anatomic landmarks in the 3D medical image;
means for extracting one or more features from each local VOI; and
means for determining a contrast phase of the at least one 3D medical image using a trained contrast phase classifier based on the extracted features.

14. The apparatus of claim 13, wherein said means for detecting a plurality of anatomic landmarks in the at least one 3D medical image comprises:
means for detecting a plurality of a target landmarks in contrast-enhancing regions of the at least one 3D medical image; and
means for detecting at least one reference landmark in a non contrast-enhancing region of the at least one 3D medical image.

15. The apparatus of claim 14, wherein said means for extracting one or more features from each local VOI comprises:
means for extracting an intensity value from the local VOI surrounding each of the plurality of target landmarks and the at least one reference landmark; and
means for calculating at least one of a ratio and a difference between each intensity value extracted for each of the plurality target landmarks and the intensity value extracted for the at least one reference landmark.

16. The apparatus of claim 13, wherein said means for estimating a local VOI surrounding each of the detected plurality of anatomic landmarks in the 3D medical image comprises:
means for detecting boundaries of a vessel corresponding to each anatomic landmark; and
means for estimating the local VOI to cover central portion of the vessel without overlapping the boundaries of the vessel.

17. The method of claim 13, wherein said means for extracting one or more features from each local VOI comprises:
means for extracting at least one of a mean intensity and a local gradient from each local VOI.

18. The apparatus of claim 1, wherein the trained contrast phase classifier is a multi-class Probabilistic Boosting Tree (PBT) classifier trained based on training images of different contrast phases.

19. The apparatus of claim 1, wherein the at least one 3D medical image comprises a multi-phase sequence of 3D medical images, and said means for determining a contrast phase of the at least one 3D medical image using a trained contrast phase classifier based on the extracted features comprises:
means for determining the contrast phase of each of the 3D medical images using a Markov model based on the extracted features for each 3D medical image and a temporal relationship between each of the 3D medial images.

20. The apparatus of claim 19, wherein said means for determining the contrast phase of each of the 3D medical images using a Markov model based on the extracted features for each 3D medical image and a temporal relationship between each of the 3D medial images comprises:
means for maximizing a probability function based on a likelihood function and a compatibility function, wherein the likelihood function is determined by the trained contrast phase classifier based on the extracted features and represents the likelihood of a certain contrast phase for each of the 3D medical images, and the compatibility function is a Gaussian distribution learned from time differences between respective ones of the 3D medical images.

21. A non-transitory computer readable medium encoded with computer executable instructions for automatic contrast phase classification in at least one 3D medical image, the computer executable instructions defining steps comprising:
detecting a plurality of anatomic landmarks in the at least one 3D medical image;
estimating a local volume of interest (VOI) surrounding each of the detected plurality of anatomic landmarks in the 3D medical image;
extracting one or more features from each local VOI; and
determining a contrast phase of the at least one 3D medical image using a trained contrast phase classifier based on the extracted features.

22. The computer readable medium of claim 21, wherein the computer executable instructions defining the step of detecting a plurality of anatomic landmarks in the at least one 3D medical image comprise computer executable instructions defining the steps of:
detecting a plurality of a target landmarks in contrast-enhancing regions of the at least one 3D medical image; and
detecting at least one reference landmark in a non contrast-enhancing region of the at least one 3D medical image.

23. The computer readable medium of claim 22, wherein the computer executable instructions defining the step of extracting one or more features from each local VOI comprise computer executable instructions defining the steps of:
extracting an intensity value from the local VOI surrounding each of the plurality of target landmarks and the at least one reference landmark; and
calculating at least one of a ratio and a difference between each intensity value extracted for each of the plurality target landmarks and the intensity value extracted for the at least one reference landmark.

24. The computer readable medium of claim 21, wherein the computer executable instructions defining the step of estimating a local VOI surrounding each of the detected plurality of anatomic landmarks in the 3D medical image comprise computer executable instructions defining the steps of:
detecting boundaries of a vessel corresponding to each anatomic landmark; and
estimating the local VOI to cover central portion of the vessel without overlapping the boundaries of the vessel.

25. The computer readable medium of claim 21, wherein the computer executable instructions defining the step of extracting one or more features from each local VOI comprise computer executable instructions defining the step of:
extracting at least one of a mean intensity and a local gradient from each local VOI.

26. The computer readable medium of claim 21, wherein the trained contrast phase classifier is a multi-class Probabilistic Boosting Tree (PBT) classifier trained based on training images of different contrast phases.

27. The computer readable medium of claim 21, wherein the at least one 3D medical image comprises a multi-phase sequence of 3D medical images, and the computer executable instructions defining the step of determining a contrast phase of the at least one 3D medical image using a trained contrast phase classifier based on the extracted features comprise computer executable instructions defining the step of:
determining the contrast phase of each of the 3D medical images using a Markov model based on the extracted features for each 3D medical image and a temporal relationship between each of the 3D medial images.

28. The computer readable medium of claim 27, wherein the computer executable instructions defining the step of determining the contrast phase of each of the 3D medical images using a Markov model based on the extracted features for each 3D medical image and a temporal relationship between each of the 3D medial images comprise computer executable instructions defining the step of:
maximizing a probability function based on a likelihood function and a compatibility function, wherein the likelihood function is determined by the trained contrast phase classifier based on the extracted features and represents the likelihood of a certain contrast phase for each of the 3D medical images, and the compatibility function is a Gaussian distribution learned from time differences between respective ones of the 3D medical images.
